(19) United States
(12) Patent Application Publication
(10) Pub. No.: US 2002/0121959 A1
(43) Pub. Date: Sep. 5, 2002

(54) Magnetic devices having single piece ferrite cores and methods of manufacture thereof

(75) Inventors: Edward Clark Fontana, Rockwall, TX (US); Simon Fraidlin, Plano, TX (US); Babatunde Aldo Onibudo, Garland, TX (US); Apurba Roy, Rockwall, TX (US); Matthew Anthony Wilkowski, Mesquite, TX (US)

Correspondence Address: HITT GAINES & BOISBRUN P.C., P.O. BOX 832570, RICHARDSON, TX, 75083, US

(73) Assignee: Lucent Technologies Inc., Murray Hill, NJ

(21) Appl. No.: 10/135,735

(22) Filed: Apr. 30, 2002

Related U.S. Application Data
(62) Division of application No. 09/120,647, filed on Jul. 22, 1998.

(51) Int. Cl. H01F 5/00

(52) U.S. Cl. 336/200

(57) ABSTRACT

A magnetic device and a method of producing the same. In one embodiment, the device includes: (1) a substantially planar printed wiring board having a plurality of traces associated therewith, (2) a magnetic core located over the board, electrically insulated from the plurality of traces and having a major axis in parallel with a plane of the board and (3) a winding assembly having a dielectric member that couples a plurality of separate electrical conductors together, the plurality of conductors overarching the core to couple with corresponding ones of the plurality of traces to form a winding for the magnetic device, the dielectric member electrically insulating the plurality of conductors from the core.

### TECHNICAL FIELD OF THE INVENTION

The present invention is directed, in general, to magnetic devices and, more specifically, to magnetic devices having single piece ferrite cores and methods of manufacturing such magnetic devices.

### BACKGROUND OF THE INVENTION

Magnetic devices, such as transformers, inductors, and integrated magnetic devices, are fundamental circuit elements that have been employed in power conversion products for many years. Magnetic devices usually comprise single or multiple turns of an electrical conductor, such as copper wire, around a core of ferrite or other magnetic material. The use of magnetic devices in the manufacture of printed circuits processed through a mass termination soldering process is fraught with design and operational problems that result in high cost. As printed circuits become smaller and more complex, the need for economical methods to incorporate magnetic devices into the manufacture of circuits has increased. Some of the practical, technical and manufacturing problems include: insulating between parts, handling of loose parts, nonidentical parts, pin rigidity during hand assembly and leakage inductance. It is also desirable that magnetic devices be readily adaptable to assembly by machine and that the basic form of the components be readily adaptable to various uses and configurations.

Numerous efforts to overcome, on an economical basis, the practical manufacturing problems of using magnetic devices, such as transformers, inductors, and integrated magnetic devices on printed circuits have been made. For example, U.S. Pat. No. 4,103,267, issued on Jul. 25, 1978, to Olschewski, entitled “Hybrid Transformer Device” and incorporated herein by reference, addressed the problem of handling the loose parts that comprise the portion of the magnetic device winding not included on the ceramic substrate of a printed circuit board. Olschewski's solution was to glue the magnetic core to the ceramic substrate of a hybrid printed circuit and use a wire bonding machine sequentially to complete each of the conductive turns initiated in the substrate. Although Olschewski's solution provided a partial answer to the problem of handling loose parts in the manufacturing process, it came with certain limitations. In an article about the process, “The Hybrid Compatible Transformer,” IEEE Transactions on Components, Hybrids and Manufacturing Technology, Volume CHMT-2, No. 4, December 1979, also incorporated herein by reference, Olschewski states that his transformer had been demonstrated to a power level of four watts, with powers of up to 25 watts being a matter of further process development to decrease winding resistance and increase heat conductivity. The use of a wire bonding machine, which was Olschewski's solution to the common problem of handling loose parts, was also the source of the upper limit on power handling capability. Furthermore, the use of a wire bonding machine to sequentially wire the transformer introduced other problems, not the least of which were logistical complications in the product delivery process.

U.S. Pat. No. 4,536,733, issued on Aug. 20, 1985, to Shelly, entitled “High Frequency Inverter Transformer for Power Supplies” and incorporated herein by reference, attempts to resolve problems of power handling and capital equipment logistical limitations. Shelly '733 is directed to forming a second winding about a toroidal core already having a first winding and addresses, at considerable manufacturing cost, the need for low leakage inductance as well as problems of power handling and pin rigidity. The second winding consists of a plurality of independently formed conductive clips including a substantially planar, wedge-shaped electrically conductive body. Unfortunately, the winding is difficult to manufacture and is inadequately isolated.

U.S. Pat. No. 4,455,545, issued on Jun. 19, 1984, also to Shelly, entitled “High Frequency Output Inductor for Inverter Power Supply” and incorporated herein by reference, is directed to an output inductor which includes a mating pair of channel shaped ferrite core blocks separated by a material having a permeability closely matching that of air. Shelly '545 illustrates the difficulties of packaging electronic circuitry and associated power supplies as well as complexities encountered in using magnetic devices with a gap separator. Shelly '545 also exemplifies the complexity of assembly and manufacture associated with gapped core assemblies.

Accordingly, what is needed in the art is a magnetic device, and a method of manufacturing such a device, that (1) permits the use of such a device in a printed circuit without requiring a plurality of independently formed parts, (2) provides for safety spacing inherent in the design and (3) provides for ease of assembly.

### SUMMARY OF THE INVENTION

To address the above-discussed deficiencies of the prior art, the present invention provides a magnetic device and a method of producing the same. In one embodiment, the device includes: (1) a substantially planar printed wiring board having a plurality of traces associated therewith, (2) a magnetic core located over the board, electrically insulated from the plurality of traces and having a major axis in parallel with a plane of the board and (3) a winding assembly having a dielectric member that couples a plurality of separate electrical conductors together, the plurality of conductors overarching the core to couple with corresponding ones of the plurality of traces to form a winding for the magnetic device, the dielectric member electrically insulating the plurality of conductors from the core.

The present invention therefore introduces the broad concept of providing a core that is oriented parallel to an underlying printed wiring board (to reduce the device's profile) and employing a winding assembly that overarches (goes over the top and extends down the sides of) the core to employ traces in the underlying board to complete the device's winding. The device may be an inductor, a transformer or integrated magnetic device (any combination of inductor(s) or transformer(s)).

In one embodiment of the present invention, the device further includes an insulating fixture, located between the board and the core, that hinders lateral movement of the core with respect to the board. In a more specific embodiment, the insulating fixture has sidewalls that further electrically insulate the plurality of conductors from the core. In an embodiment to be illustrated and described, the fixture takes the form of a plastic box that may be fixed to the underlying board. The core can then be dropped into the fixture in an automated process during device assembly.

In one embodiment of the present invention, the dielectric member has sidewalls that electrically insulate the plurality of conductors from the core. In an embodiment to be illustrated and described, the sidewalls of the dielectric member are further employed to shape the plurality of conductors into an appropriate profile for overarching the core.

In one embodiment of the present invention, the core has a sinter-survivable gap. The sinter-survivable gap may be a gap, notch or other suitable absence of magnetic material as desired.

In one embodiment of the present invention, the device further includes a second winding about the core, the device being a selected one of: (1) a transformer and (2) an integrated magnetic device. In an embodiment to be illustrated and described, the second winding takes the form of an applique that may be applied to the core before it is deposited into the fixture. Alternatively or additionally, other windings may be formed by cooperations of other winding assemblies and corresponding traces.

In one embodiment of the present invention, the plurality of conductors are surface-mounted to the board. Alternatively, the conductors may be through-hole mounted to the board or mounted by any other conventional or later-discovered technique.

In one embodiment of the present invention, a power supply is located at least partially on the board and is coupled to the device. Thus, the device may be a power magnetic device, forming a portion of a power supply. Alternatively, the device may form a portion of a signal communication or processing circuit.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates an isometric view of one embodiment of a magnetic device constructed according to the principles of the present invention;

FIG. 2 illustrates an exploded isometric view of the magnetic device of FIG. 1;

FIG. 3 illustrates a diagram of a method of manufacturing a magnetic device carried out according to the principles of the present invention;

FIGS. 4a and 4b illustrate isometric views of one embodiment of a winding assembly that may be employed in the magnetic device of FIG. 1;

FIG. 5 illustrates an isometric view of one embodiment of an insulating fixture that may be employed in the magnetic device of FIG. 1;

FIG. 6 illustrates an isometric view of one embodiment of an a core having an applique winding that may be employed in the magnetic device of FIG. 1; and

FIGS. 7a-7d illustrate isometric views of cores having various types of sinter-survivable gaps therein that may be employed in the magnetic device of FIG. 1.

### DETAILED DESCRIPTION

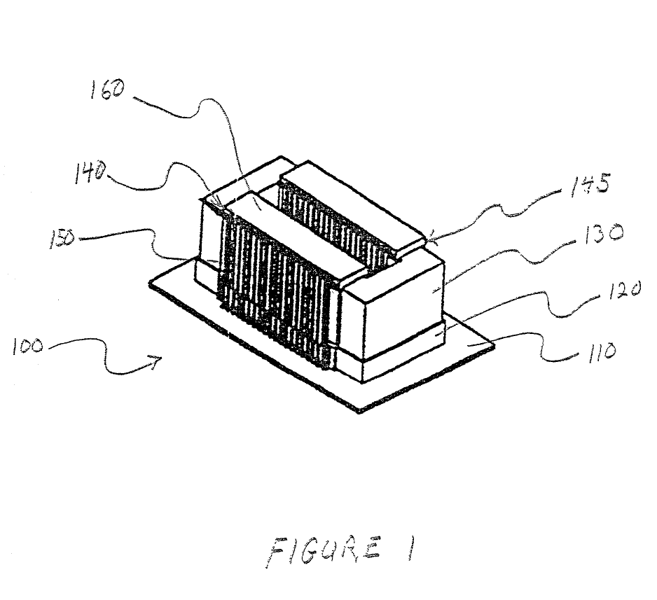

Referring initially to FIG. 1, illustrated is an isometric view of one embodiment of a magnetic device constructed according to the principles of the present invention. The magnetic device, generally designated 100, is positioned over a substantially planar printed wiring board (PWB) 110 having a plurality of traces associated with it. The magnetic core 130 of the device 100 is positioned over the PWB 110 with the major axis of the core 130 parallel to the geometric plane of the PWB 110. The magnetic core 130 is electrically insulated from the plurality of traces associated with the PWB 110 by using, in this embodiment, an insulating fixture 120. Overarching the magnetic core 130 are two identical winding assemblies 140, 145. Because the winding assemblies 140, 145 are identical, references herein will be to winding assembly 140 and its component parts, unless otherwise specified. Winding assembly 140 consists of a plurality of separate electrical conductors 150 coupled together with a dielectric member 160. The dielectric member 160 keeps the plurality of electrical conductors 150 separate from each other, as well as electrically insulating said electrical conductors 150 from the magnetic core 130.

With the winding assembly 140 positioned to overarch the magnetic core 130, the plurality of electrical conductors 150 are coupled to the corresponding plurality of traces associated with the PWB 110. The electrical conductors 150 can be surface-mounted to the PWB or coupled to the plurality of traces by using through-hole mounting methods, as well as any other conventional or later-discovered technique. When coupled together, the electrical conductors 150 and the plurality of traces form a winding for the magnetic device 100.

The two winding assemblies 140, 145 permit the magnetic device 100 to be used as either a transformer or an integrated magnetic device. Those skilled in the art will understand that this is but one embodiment of the present invention. One or a plurality of winding assemblies 140 can be used to complete windings on a magnetic device 100 to permit it to be used as an inductor, transformer or integrated magnetic device. Taps can be made off intermediary fractions of a winding assembly 140. More than one of such winding assembly 140 can be used in series or in parallel, depending on circuit or design requirements.

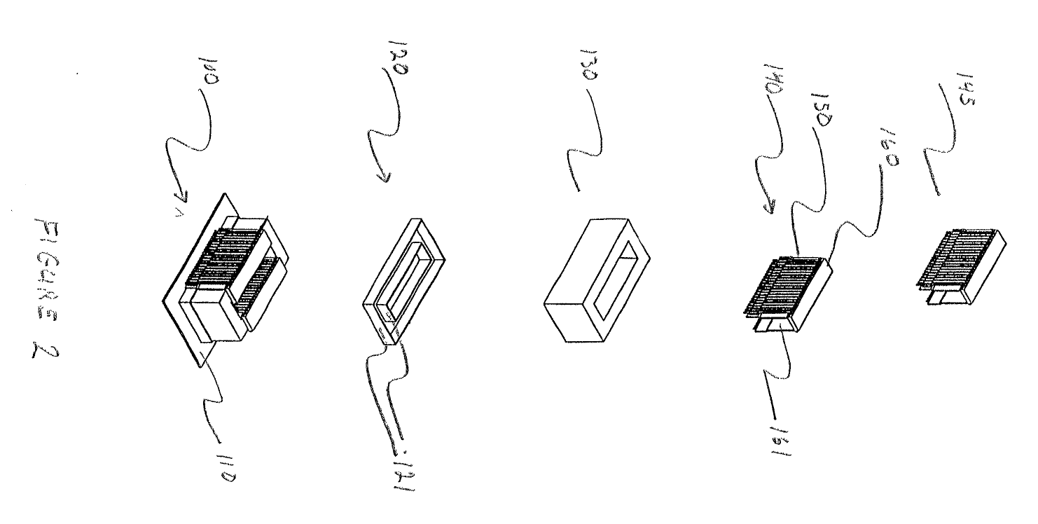

Turning now to FIG. 2, illustrated is an exploded isometric view of the magnetic device of FIG. 1. In this embodiment the insulating fixture 120 has sidewalls 121 that give it a box-like shape. When the insulating fixture 120 is fastened to the PWB 110, this box-like shape hinders lateral movement of the magnetic core 100 with respect to the PWB 110. This is one of several shapes or forms that can be used to hinder lateral movement. For example, the insulating fixture 120 could have molded corners, prongs that plug into the core 130 tabs along the perimeter of the fixture 120, all of which would serve to secure the core 130 and hinder lateral movement. Of course, other conventional or later discovered techniques can by used in connection with the insulating fixture 120 to hinder lateral movement of the core 130 with respect to the PWB 110.

A feature of having sidewalls 121 on the insulating fixture 120 is that such sidewalls 121 can be used to further insulate the electrical conductors 150 from the core 130. In fact, by varying the height of the sidewalls 121, all or a portion of the required electrical insulation between the conductors 150 and the core 130 can be provided.

When the insulating fixture 120 includes sidewalls 121, the insulating fixture 120 can also serve as a receptacle or “bucket” to aid in the assembly process of attaching a magnetic device 100 to the PWB 110. Thus shaped, the insulating fixture 130 facilitates a more efficient and less costly assembly process, because the fixture 120 can then serve as a guide into which the magnetic core 130 can be easily inserted. The core 130 can be inserted with or without an associated winding assembly 140 in place. This feature permits the use of an automated assembly process and also serves as an aid to hand assembly. Other features to facilitate assembly that may be included are guide holes or grooves in the insulating fixture 130 to guide the individual conductors 150 to the appropriate match with the individual traces associated with the PWB 110.

In the view of the winding assembly 140 illustrated in FIG. 2, the dielectric member 160 also has sidewalls 161. Similar to the sidewalls 121 on the insulating fixture 120, the dielectric sidewalls 161 electrically insulate the core 130 from the overarching conductors 150. Of course, the height of the dielectric sidewalls 161 can be varied to accommodate various design considerations.

One advantageous feature of the dielectric sidewalls 161 and the insulating fixture sidewalls 121 is that the respective sidewalls 121, 161 can be used in association to provide necessary electrical insulation. For example, thickness and height can be varied to share the insulation function or, if required, to permit air to serve as the dielectric between the conductors 150 and the core 130.

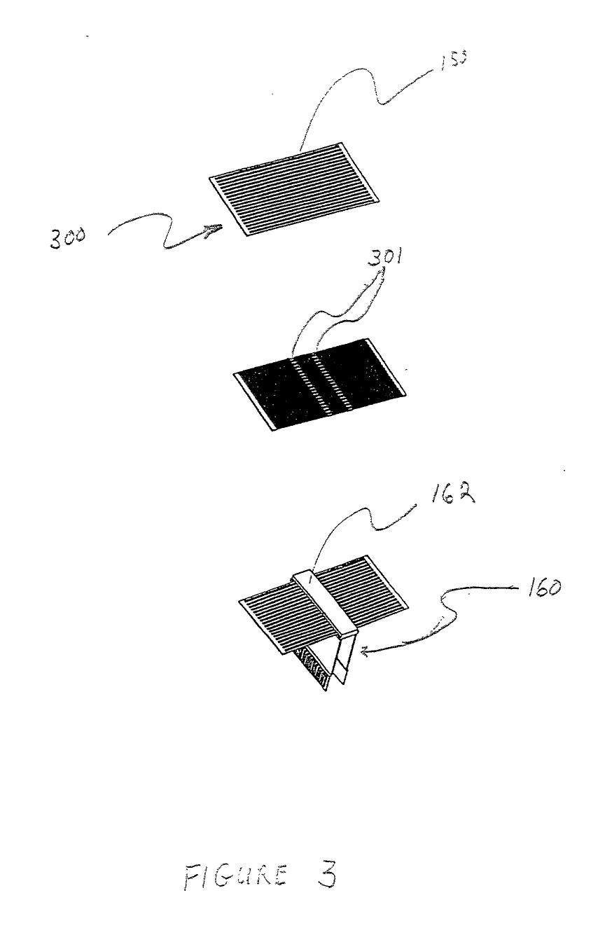

Turning now to FIG. 3, illustrated is a diagram of a method of manufacturing a magnetic device carried out according to the principles of the present invention. Illustrated is a strip 300 of a plurality of separate electrical conductors 150 that has been formed in a progressive die, or other conventional or later discovered technique. Because the strip 300 is to be folded into a “U” shape when incorporated into the winding assembly 140, areas 301 that will be bent or interact with an injection molding process are left flat. The strip 300 can then be coupled to the dielectric member 160 by a variety of methods. One method is to mold the material comprising the dielectric member 160 around the strip 300 by using an injection molding procedure, or equivalent. Another method is to place the strip 300 between an independently formed one or two piece dielectric cap 162 that snaps together, trapping the strip 300 and holding it in position. In the completed winding assembly 140, the strip 310 is formed in a “U” shape so that it overarches the core 130. To facilitate the correct shaping of the strip 300, the dielectric member 160 can be shaped to serve as an assembly guide. The dielectric member 160 also functions to maintain spacing between the separate electrical conductors 150 during assembly.

Referring back to FIG. 2 for the remainder of the assembly process, the magnetic core 130 is then located over a PWB 110 with the major axis of the core 130 parallel to the geometric plane of the PWB 110. The PWB 110 will have a plurality of traces associated with it in a manner familiar to those skilled in the art. The magnetic core 130 will be electrically insulated from the plurality of traces, which electrical insulation may take any one of several forms, including using the board itself as the medium to provide insulation or using an insulating fixture 120. Overarching the magnetic core 130 will be placed one or more winding assembly's 140. The plurality of separate electrical conductors 150 will be insulated electrically from the magnetic core 120 by the dielectric member 160. Further insulation may be provided by sidewalls 121 on the insulating fixture 120 or sidewalls 161 on the dielectric member 160. The electrical conductors 150 are then coupled or connected to the corresponding plurality of traces associated with the PWB 110. Such coupling or connection can be made by surface mounting the plurality of electrical conductors 150 to the PWB 110. Alternatively, the coupling can be made by through-hole mounting to the PWB 110 or other conventional or later discovered technique.

In the illustrated embodiment, an insulating fixture 120 is fastened to the PWB 110 by glue, snap fasteners or other conventional method. Because the insulating fixture 120 in the illustrated embodiment has sidewalls 121, the insulating fixture 120 acts as a stabilizing device to hinder lateral movement. As previously discussed, the sidewalls 121 may further serve as an aid in the assembly process by acting as a guide into which the core 130 can be dropped in an automated assembly process or inserted by hand.

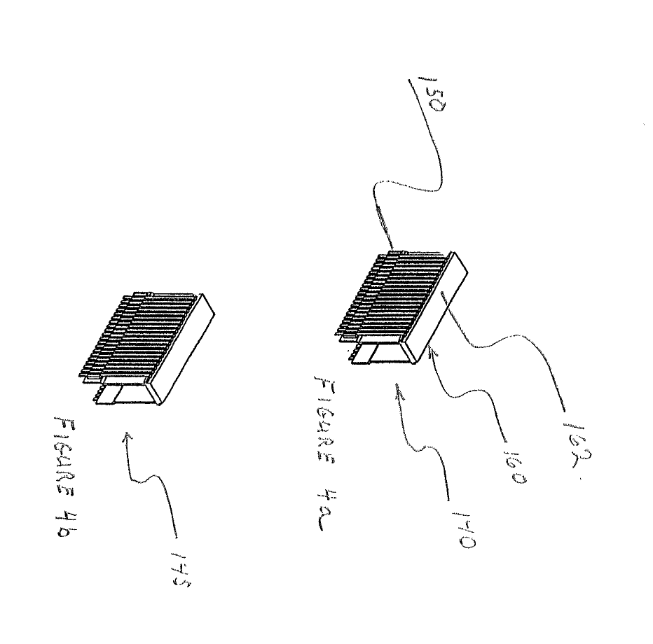

Turning now to FIGS. 4a and 4b, illustrated are isometric views of one embodiment of a winding assembly that may be employed in the magnetic device of FIG. 1. Illustrated is the embodiment of the winding assembly 140 constructed by the method described with reference to FIG. 3, above. As previously described, the dielectric member 160 can be made with a one or two piece cap 162 that snaps together trapping the conductors 150 between them. The dielectric member 160 can also be molded as a single piece dielectric member 160 with the conductors 150 molded into position. Those skilled in the art will understand that the invention is not limited to the illustrated embodiment.

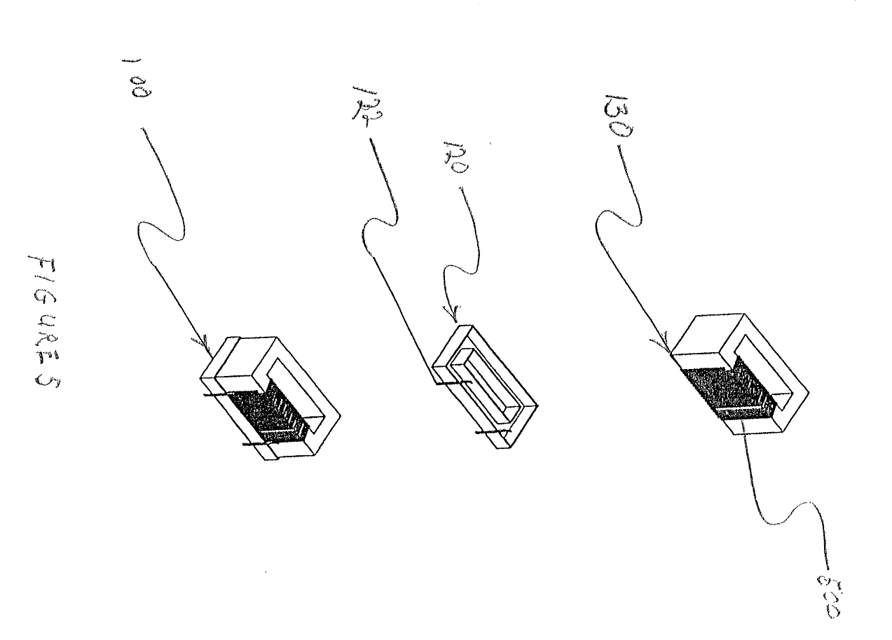

Turning now to FIG. 5, illustrated is an isometric view of one embodiment of an insulating fixture that may be employed in the magnetic device of FIG. 1. In this embodiment the insulating fixture 120 has spring contacts 122 and the magnetic core 130 has an integral winding. The spring contacts 122 can be attached to the integral winding 500 by solder or any other conventional or later discovered technique. The spring contacts 122 can then be used to couple the magnetic device 100 into a circuit. This embodiment provides electrical insulation and ready electrical connectivity in manufacturing processes where a magnetic device 100 is to be used as a component.

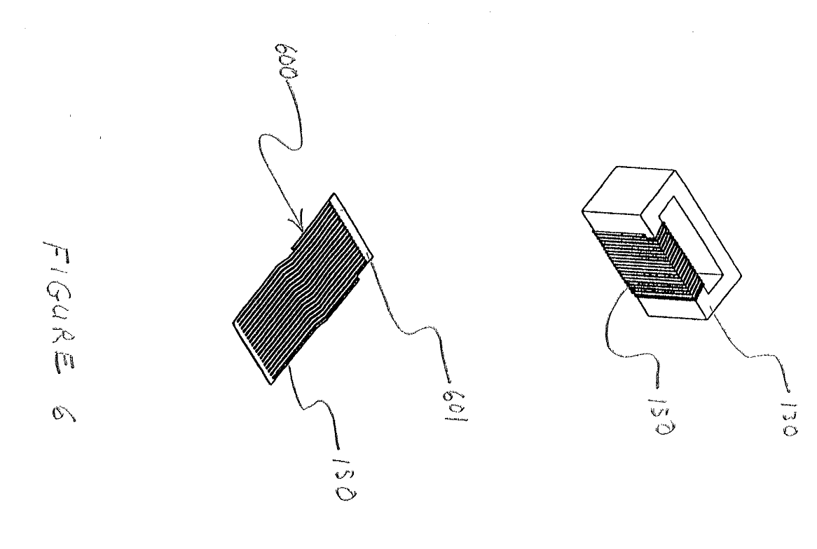

Turning now to FIG. 6, illustrated is an isometric view of one embodiment of a core having an applique winding that may be employed in the magnetic device of FIG. 1. In this embodiment, a winding strip 600 is formed by applying a flexible applique 601 to a strip of electrical conductors 150. The applique 601 serves to maintain dimensional and positional integrity of the electrical conductors 150 during the assembly process. Assembly of the magnetic device is simplified because electrical conductors 150 can be applied to a core 130 by means of a single turn of a continuous strip 600. Choice of assembly methods is broadened because the flexible applique 601 can be either a conductive tape fused to the magnetic core 130 during assembly or a seeding substance that allows the conductive material to be added by a subsequent process, such as electroplating.

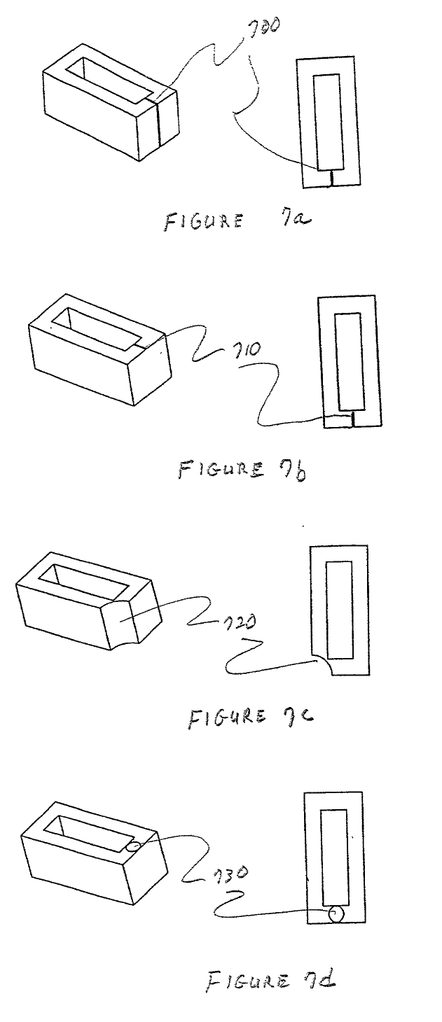

Turning now to FIGS. 7a-7d, illustrated are isometric views of cores having various types of sinter-survivable gaps therein that may be employed in the magnetic device of FIG. 1. A principal attribute of the invention is that a single piece magnetic core 130 incorporating sinter-survivable gaps can be used to assemble magnetic devices 100. FIG. 7a shows an embodiment of a magnetic core 130 with a sinter-survivable gap produced with a rectangular cross section 700. FIG. 7b shows an embodiment of a magnetic core 130 with a sinter-survivable gap produced with a notch 710. FIG. 7c shows a magnetic core 130 with an embodiment of a sinter survivable gap produced with a missing corner 720. FIG. 7d shows a magnetic core 130 with an embodiment of a sinter-survivable gap produced with a round pin 730. The foregoing illustrations are embodiments of some, but not all, of the various possibilities incorporating sinter-survivable gaps. The sinter-survivable gaps shown in FIGS. 7a-7d can be singular or a plurality of gaps and they may incorporate other gap designs. Any one of these embodiments may readily be substituted for the magnetic core 130, previously described in FIG. 1. The benefits of using the invention in assembling gapped core structures are that the number of parts handled during assembly is reduced, a mistake free gap with fewer secondary operations can be produced and the need to split the core into two parts for winding assembly purposes is eliminated.

One attribute of the invention is that the magnetic device 100 can be included in a circuit where the PWB 110 on which it is mounted is only a part. The magnetic device 100 may serve as a single component of a power supply, signal communication or processing service, only a part of which is on one PWB 110. The magnetic device 100 may also be coupled to one or more PWBs containing other components of a power supply, signal communication or processing service.

Although the present invention has been described in detail, those skilled in the art should understand that they can make various changes, substitutions and alterations herein without departing from the spirit and scope of the invention in its broadest form.

What is claimed is:

1. A magnetic device, comprising:
a substantially planar printed wiring board having a plurality of traces associated therewith;
a magnetic core located over said board, electrically insulated from said plurality of traces and having a major axis in parallel with a plane of said board; and
a winding assembly having a dielectric member that couples a plurality of separate electrical conductors together, said plurality of conductors overarching said core to couple with corresponding ones of said plurality of traces to form a winding for said magnetic device, said dielectric member electrically insulating said plurality of conductors from said core.

2. The device as recited in claim 1 further comprising an insulating fixture, located between said board and said core, that hinders lateral movement of said core with respect to said board.

3. The device as recited in claim 2 wherein said insulating fixture has sidewalls that further electrically insulate said plurality of conductors from said core.

4. The device as recited in claim 1 wherein said dielectric member has sidewalls that electrically insulate said plurality of conductors from said core.

5. The device as recited in claim 1 wherein said core has a sinter-survivable gap.

6. The device as recited in claim 1 further comprising a second winding about said core, said device being a selected one of:
a transformer, and
an integrated magnetic device.

7. The device as recited in claim 1 wherein said plurality of conductors are surface-mounted to said board.

8. A method of manufacturing a magnetic device, comprising:
forming a plurality of traces on a substantially planar printed wiring board;
placing a magnetic core over said board, said core being electrically insulated from said plurality of traces and having a major axis in parallel with a plane of said board;
overarching said core with a winding assembly having a dielectric member that couples a plurality of separate electrical conductors together; and
coupling said plurality of conductors with corresponding ones of said plurality of traces to form a winding for said magnetic device, said dielectric member electrically insulating said plurality of conductors from said core.

9. The method as recited in claim 8 further comprising locating an insulating fixture between said board and said core, said fixture hindering lateral movement of said core with respect to said board.

10. The method as recited in claim 9 wherein said insulating fixture has sidewalls, said method further comprising further electrically insulating said plurality of conductors from said core with said sidewalls.

11. The method as recited in claim 8 wherein said dielectric member has sidewalls, said method further comprising further electrically insulating said plurality of conductors from said core with said sidewalls.

12. The method as recited in claim 8 wherein said core has a sinter-survivable gap.

13. The method as recited in claim 8 further comprising disposing a second winding about said core, said device being a selected one of:
a transformer, and
an integrated magnetic device.

14. The method as recited in claim 8 wherein said coupling comprises surface-mounting said plurality of conductors to said board.

15. A magnetic device, comprising:
a substantially planar printed wiring board having a plurality of traces associated therewith;
an insulating fixture, located between said board and said core;
a magnetic core located over said fixture, electrically insulated from said plurality of traces and having a major axis in parallel with a plane of said board, said fixture hindering lateral movement of said core with respect to said board; and
a winding assembly having a dielectric member that couples a plurality of separate electrical conductors together, said plurality of conductors overarching said core to couple with corresponding ones of said plurality of traces to form a winding for said magnetic device, said dielectric member electrically insulating said plurality of conductors from said core, said fixture having sidewalls that further electrically insulate said plurality of conductors from said core.

16. The device as recited in claim 15 wherein said dielectric member has sidewalls that electrically insulate said plurality of conductors from said core.

17. The device as recited in claim 15 wherein said core has a sinter-survivable gap.

18. The device as recited in claim 15 further comprising a second winding about said core, said device being a selected one of:
a transformer, and
an integrated magnetic device.

19. The device as recited in claim 15 wherein said plurality of conductors are surface-mounted to said board.

20. The device as recited in claim 15 wherein a power supply is located at least partially on said board and is coupled to said device.
